(19) United States
(12) Patent Application Publication
(10) Pub. No.: US 2008/0147841 A1
(43) Pub. Date: Jun. 19, 2008

(54) Annotation management program, device, and method

(75) Inventors: Fumihito Nishino, Kawasaki (JP); Terunobu Kume, Kawasaki (JP)

Correspondence Address: GREER, BURNS & CRAIN, 300 S WACKER DR, 25TH FLOOR, CHICAGO, IL, 60606, US

(73) Assignee: Fujitsu Limited, Kawasaki-shi (JP)

(21) Appl. No.: 11/983,484

(22) Filed: Nov. 9, 2007

(30) Foreign Application Priority Data
Dec. 13, 2006 (JP) 2006-336143

(51) Int. Cl. G06F 15/173

(52) U.S. Cl. 709/223; 707/E17.107

(57) ABSTRACT

Receiving an operation request, a management module determines whether a user who sent the operation request has authorization to annotate based on information acquired from a user management table of a web server to an authorization management table in advance. When the user has authorization to annotate, the management module registers the annotation data into an annotation database.

### BACKGROUND

The present invention relates to a program, a device, and a method for managing annotations.

As everyone knows, an annotation in a book is information about an interpretation of a phrase in a body and information about a reference document that are described in a page corner or in a chapter end. On the other hand, an annotation in web page data is attendant information that is linked to a part (a character string, an image) in a web page without modifying the resource itself by a technique such as XLink (XML Linking Language).

With the annotation technique, an annotation server is introduced in a network apart from a web server, and a program for an annotation is installed into a web client as extension. When a part on a web page displayed by a web client program (a web browser) is selected and contents that should be linked to the selected part is inputted as an annotation, the extension concerned notifies the input contents, the internal address of the part linked to the contents, and the network address of the web page data to the annotation server. When receiving the contents, internal address, and network address, the annotation server issues a unique annotation ID (Identification), and registers it to an annotation database as annotation data in association with the contents, internal address, and network address of the annotation. When the web client acquires web page data from the web server, the extension concerned inquires about the presence or absence of annotation data linked to the web page. If the annotation exists, the extension acquires the annotation data from the annotation server and superimposes the annotation over the web page. The extension concerned requires the annotation server to correct or to delete the annotation that is selected by an operator among annotations linked to a web page according to a direction of the operator.

Japanese patent publication 3771831, Japanese unexamined patent publication 2004-046745, Japanese patent publication 3594231, International publication 03/091889, and Japanese unexamined patent publication 2005-339278 disclose such a conventional annotation technique.

In the conventional annotation technique, a user at a web client side links static information to a part of a web page that cannot be edited at the web client side. That is, a person who is completely different from an administration of a web page can generate, correct, and delete an annotation independently of uploading a web page to the Internet, deleting it, and changing its contents.

Under such a circumstance, a creation, a correction and a deletion of an annotation by an annotator who creates an annotation can be restricted using the usual access control technique that uses the cookie function, for example. However, an administrator of a web page to which an annotation is linked cannot restrict a creation, a correction and a deletion of an annotation that links to the web page.

As mentioned above, according to the conventional technique, if a user at the web client side links an annotation to a web page, the annotation is displayed over the web page. However, in order to stop a display of a registered annotation, a user must delete the annotation positively. Therefore, the conventional annotation technique cannot stop a display of annotation automatically after indications of a predetermined frequency, and cannot display an annotation after a predetermined time elapses.

### SUMMARY

The present invention is developed in view of the problems of the conventional technique mentioned above. A first object of the present invention is to enable an administrator of a web page to restrict an annotation linked to the web page. A second object of the present invention is to enable an annotator to control a display of an annotation.

In order to achieve the above-mentioned first object, an annotation management program of a first aspect according to the present invention controls a computer to execute functions including:

a storing function for storing annotation data, which includes a network address about web page data, contents information for specifying an annotation related with a web page corresponding to the web page data, and an internal address for specifying a position to which the annotation is linked on said web page, into an annotation database in a storage device;

a receiving function for receiving request information, which includes operation type information that specifies a type of an operation about an annotation and annotation information that specifies annotation data used for the operation, from a web client through a communication device;

a determination function for determining whether the request information satisfies a predetermined condition when the receiving function receives the request information; and

an execution function for executing the operation specified by the operation type information included in the request information to the annotation database when the determination function determines that the request information satisfies the predetermined condition.

With this configuration, the computer executes the operation specified by the operation type information included in the request information only when the request information received from the web client satisfies the predetermined condition. Here, if the predetermined condition is selected suitably, the operation concerning an annotation (a registration, a correction, and a deletion of annotation data) is restricted appropriately.

In the annotation management program of the first aspect of the present invention, the information that specifies the predetermined condition may be stored in the storage device, or may be stored in another computer. In the latter case, the information that specifies the predetermined condition can be collected from a table that a web server uses for access restriction to a web page, or can be collected from the data embedded into the web page data.

In order to achieve the above-mentioned first object, an annotation management program of a second aspect according to the present invention controls a computer to execute functions including:

a receiving function for receiving annotation data, which includes a network address about web page data, contents information for specifying an annotation related with a web page corresponding to the web page data, and an internal address for specifying a position to which the annotation is linked on the web page, from a web client through a communication device;

a determination function for determining whether the annotation data satisfies a predetermined condition when the receiving function receives the request information; and

a registration function for registering the annotation data into an annotation database when the determination function determines that the annotation data satisfies the predetermined condition.

With this configuration, the computer registers the annotation data into the annotation database only when the annotation data received from the web client satisfies the predetermined condition. Here, if the predetermined condition is selected suitably, the registration of the annotation data is restricted appropriately. Therefore, the administrator of the computer concerned can restrict an operation concerning an annotation appropriately by selecting the condition suitably. The predetermined condition may be a condition for judging whether the contents of the annotation are appropriate, or it may be a condition for judging whether a creator of the annotation is appropriate.

In order to achieve the above-mentioned second object, an annotation management program of a third aspect according to the present invention controls a computer to execute functions including:

a receiving function for receiving annotation data, which includes a network address about web page data, contents information for specifying an annotation related with a web page corresponding to the web page data, and an internal address for specifying a position to which the annotation is linked on the web page, and action related information, which includes form specifying information for specifying a display form of the annotation after a change, and condition information for specifying a condition that causes the change, from a web client through a communication device;

a registration function for registering the annotation data into an annotation database and for registering the action related information into a management table when the receiving function receives the annotation data and the action related information;

a determination function for determining whether a condition specified by the condition information included in the action related information is satisfied for each of pieces of the action related information; and

a switching function for switching the status of the corresponding annotation data in the annotation database so that the display form of the annotation matches the display form specified by the form specifying information when the determination function determines that the condition is satisfied.

With this configuration, the computer receives the action related information as well as the annotation data from the web client. Then, the computer registers the annotation data into the annotation database and registers the action related information into the management table. The computer monitors whether the condition specified by the condition information included in the action related information is satisfied for each of pieces of the action related information in the management table.

Further, the computer operates so that the display form of the annotation matches the display form specified by the form specifying information when the condition is satisfied. Here, the action related information is created by the annotator who is going to register an annotation through a web client. That is, the annotator can control the display of the annotation by registering suitable action related information as well as annotation data.

As described above, according to the present invention, an administrator of a web page can restrict an annotation to the web page, and an annotator can control a display of an annotation.

### DESCRIPTION OF THE ACCOMPANYING DRAWINGS

FIG. 1 is a block diagram showing a computer network system of a first embodiment,

FIG. 2 shows an example of a data structure of annotation data,

FIG. 3(a) is a flowchart showing a first part of a process by the edit module program according to the first embodiment,

FIG. 3(b) is a flowchart showing a second part of the process by the edit module program according to the first embodiment,

FIG. 3(c) is a flowchart showing a third part of the process by the edit module program according to the first embodiment,

FIG. 4(a) is a flowchart showing a part of a process by a management module program according to the first embodiment,

FIG. 4(b) is a flowchart showing the other part of the process by the management module program according to the first embodiment,

FIG. 5 is a block diagram showing a computer network system of a second embodiment.

FIG. 6 is a flowchart showing a process by a management module program according to the second embodiment,

FIG. 7 is a block diagram showing a computer network system of a third embodiment,

FIG. 8(a) is a flowchart showing one part of a process by a management module program according to the third embodiment,

FIG. 8(b) is a flowchart showing the other part of the process by the management module program according to the third embodiment,

FIG. 9 is a block diagram showing a computer network system of a fourth embodiment.

FIG. 10 shows an example of a data structure of a status management table,

FIG. 11(a) is a flowchart showing a part of a process by an edit module program according to the fourth embodiment,

FIG. 11(b) is a flowchart showing the other part of the process by the edit module program according to the fourth embodiment,

FIG. 12 is a flowchart showing a process by a management module program according to the fourth embodiment, and

FIG. 13 is a flowchart showing a process by a monitoring module program.

### DESCRIPTION OF THE PREFERRED EMBODIMENTS

Four embodiments of the present invention will be described with reference to the accompanying drawings.

### First Embodiment

First, a hardware configuration and a software configuration of the computer network system according to the first embodiment will be described.

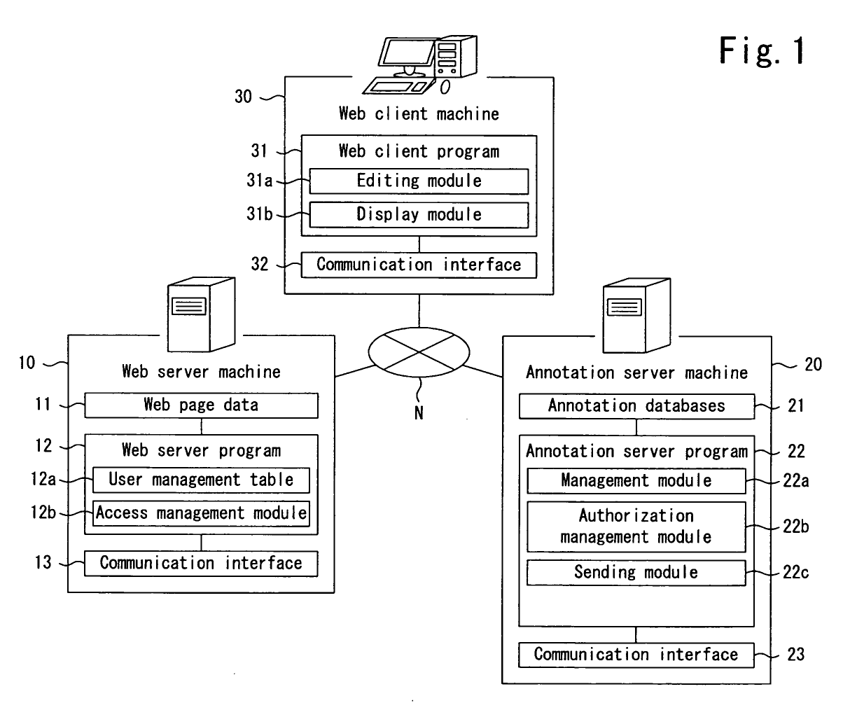

FIG. 1 shows a system configuration of a computer network system of the first embodiment.

The computer network system of the first embodiment consists of a web server machine 10, an annotation server machine 20, and a web client machine 30. The machines 10, 20, and 30 are connected via a network N so that they can communicate mutually.

The web server machine 10 is a general purpose computer to which a function as a web server is added. Therefore, the web server machine 10 contains at least a storage device, a CPU (Central Processing Unit), a DRAM (Dynamic Random Access Memory), and a communication adapter that are not illustrated. The storage device stores various kinds of application programs and data. The CPU is a processing unit that processes according to a program within the storage device. The DRAM is a volatile memory device to which a program is cashed and workspace is developed when the CPU processes. The communication adapter is a communication device that exchanges data with other computers on the network N.

The storage device of the web server machine 10 stores web page data 11, a web server program 12, and a communication interface program 13.

The web page data 11 is HTML (HyperText Markup Language) data that is provided to other computers through the network N. A unique URL (Uniform Resource Locator) is assigned to each the web page data 11 as a network address.

Receiving an HTTP (HyperText Transfer Protocol) request message with specification of URL from a web client machine 30, the web server program 12 sends an HTTP response message containing web page data 11 of the web page defined by the URL. The web server program 12 includes a user management table 12a and an access management module program 12b.

The user management table 12a is a table for managing the information about users whom the web server program 12 permits to provide the web page data 11. A record of the user management table 12a at least has a field that records information for identifying a user (user ID (Identification)), a field that records the password information that is compared with data inputted by a user to get an access permission, and a field that records a path of web page data that gives an access permission to the user.

The access management module program 12b determines whether a requested web page data can be sent to the web client machine 30 when the web server program 12 receives an HTTP request message from the web client machine 30. If the access management module program 12b permits a sending, the web server program 12 sends the requested web page data to the web client machine 30 that requested.

The communication interface program 13 is a protocol stack (program) for exchanging the data with other computers through the network N according to TCP/IP (Transmission Control Protocol/Internet Protocol).

The annotation server machine 20 is a general purpose computer to which a function of the annotation server is added. Therefore, the annotation server machine 20 contains at least a storage device, a CPU, a DRAM, and a communication adapter that are not illustrated.

The storage device of the annotation server machine 20 stores an annotation database 21, an annotation server program 22, and a communication interface program 23. Here, an annotation is attendant information that is linked to a part (a character string, an image) in a web page without reference to a source text by a technique such as XLink (XML Linking Language).

The annotation database 21 is a function (table group and program group) for storing annotation data with enabling free search. The annotation data includes at least a network address (URL) of web page data, an internal address for specifying a position to which the annotation is linked on the web page, contents information for specifying contents of the annotation, information about creation of the contents (a name of annotator (a user who annotated), a date and time of creation, etc.), and an annotation ID (Identification) for specifying each annotation individually. The internal address included in the annotation data may be information that specifies a root and a node of each of blocks that are related to one another in a tree structure in a source text, like the data described according to XPath (XML Path Language), or may be a block ID that is uniquely assigned to each block. Anyway, the annotation data uses the abstract information that logically specifies the position of an object (character string) to which the annotation is linked as the internal address.

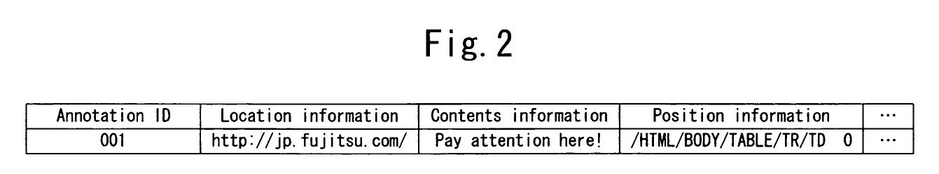

FIG. 2 shows an example of the data structure of the annotation data.

As shown in FIG. 2, the annotation data includes fields for recording annotation ID, network address, contents information, and an internal address at least. In FIG. 2, the network address is a URL. The internal address of the annotation shown in FIG. 2 consists of data described by XPath, and an offset that is the number of characters counted from the head to an object starting position in the block specified by the data. The annotation data may include date and time of generation of the annotation, a name of an annotator (a user who annotated), a size (the number of characters) of an object, or the like in addition to the above information.

The annotation server program 22 of FIG. 1 is used to execute the process about annotation at the server side. The annotation server program 22 contains a management module program 22a, an authorization management table 22b, and a sending module program 22c.

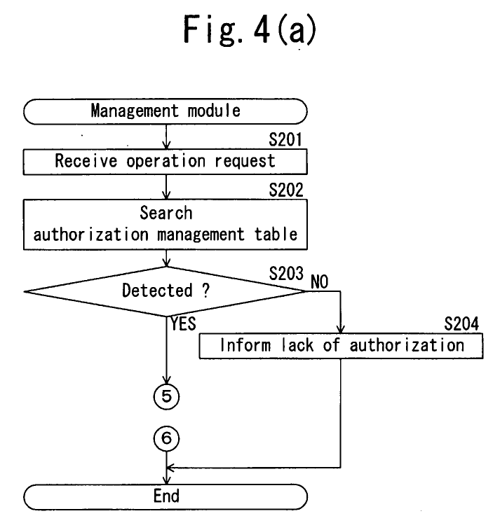

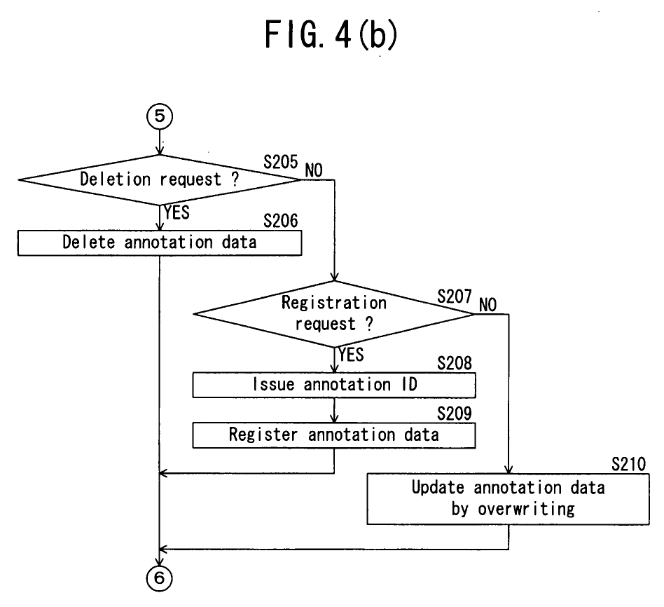

The management module program 22a is used to register, correct, or delete the annotation data with respect to the annotation database 21 according to an operational direction from the web client machine 30. The processes executed by the CPU (not shown) according to the management module program 22a will be described below with reference to FIG. 4(a) and FIG. 4(b).

The authorization management table 22b is a table for managing the information about a user who is permitted to annotate. A record of the authorization management table 22b has a field that records information for identifying a user (user ID (Identification)), a field that records the password information that is compared with data inputted by a user to get annotation permission, and a field that records network address of web page data that permits an annotation to the user. Here, the records stored in the authorization management table 22b may be created by copying the values in the user ID field, the password information field, and the path field of the records stored in the user management table 12a of the web server machine 10. In order to copy the values, the annotation server program 22 may include a function (module program) for updating the authorization management table 22b periodically by copying the records from the user management table 12a of the web server machine 10. Further, the record stored in the authorization management table 22b may include a type of operation (registration, correction, deletion of an annotation) that is permitted to the user, and a condition (date and time of generation of the annotation, a name of an annotator, etc.) of annotation data that permits an operation to the user in addition to the user information, the password information, and the network address. Since the operation type and the condition of annotation data cannot be copied from the user management table 12a of the web server machine 10, the administrator of the annotation server 20 etc. needs to register these data into the annotation database 21 in advance. The annotation server machine 20 that stores the information about the user who is permitted to annotate into the authorization management table 22b corresponds to the storing function.

The sending module program 22c is used to send annotation data from the annotation database 21 to the web client machine 30 in response to a request from the web client machine 30.

The communication interface program 23 is a TCP/IP stack as in the case of the web server machine 10.

The web client machine 30 is a personal computer to which the function of the web client is added. Therefore, the web client machine 30 consists of a display such as a liquid crystal display, input devices such as a keyboard and a mouse, and a main body to which these devices are connected. The main body contains a storage device, a CPU and a DRAM, and the communication adapter.

The storage device of the web client machine 30 stores a web client program 31, and a communication interface program 32.

The web client program 31 is used to acquire the web page data in the web server machine 10 through the exchange of HTTP messages with the web server (function based on a program) 12, and to display the web page on the display. The web client program 31 contains an editing module program 31a and a display module program 31b as module programs for extensions.

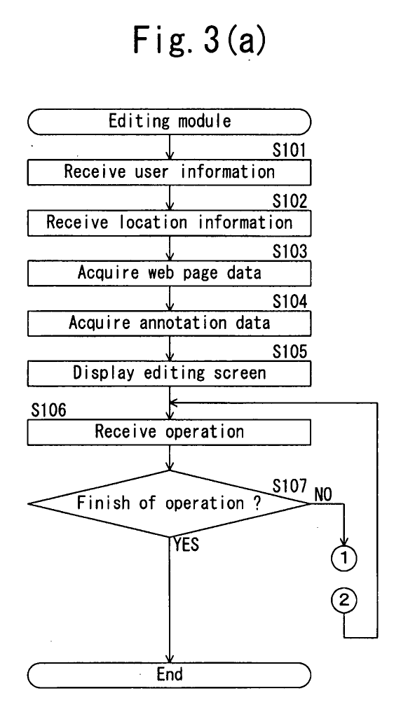

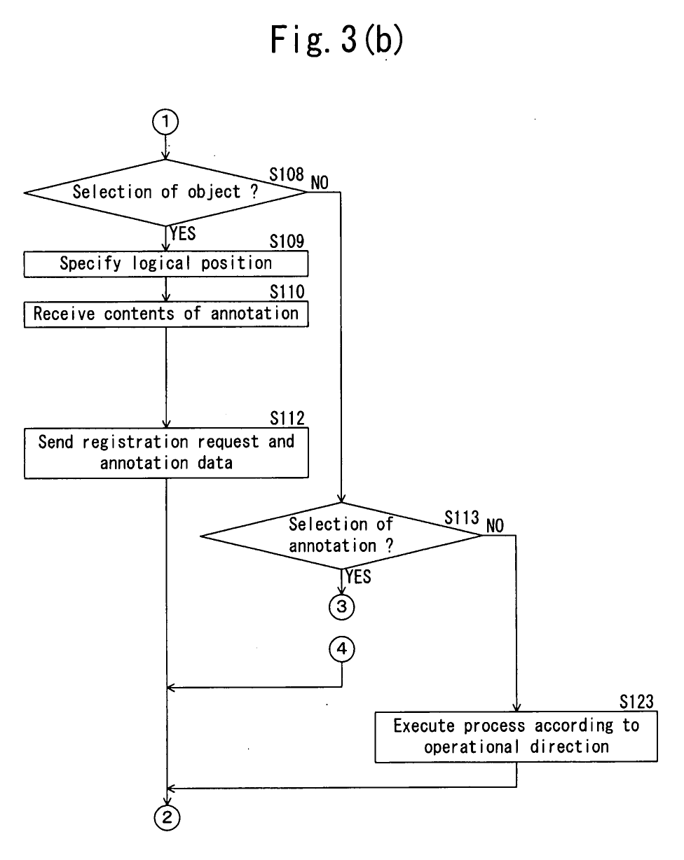

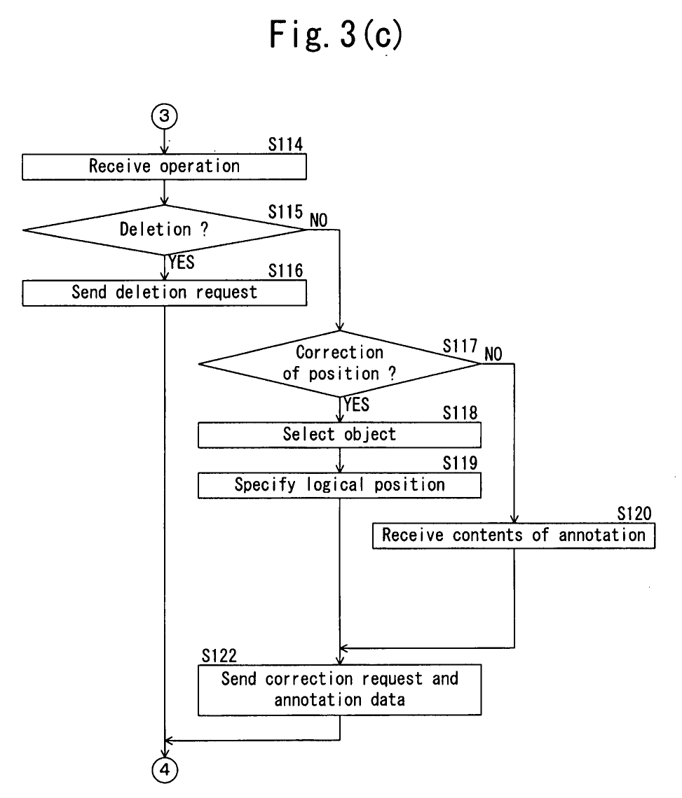

The editing module program 31a is used to send the operational direction about registration, correction, or deletion of the annotation data to the management module (function based on a program) 22a of the annotation server (function based on a program) 22. Regarding the registration and the update of contents information of annotation data, the editing module program 31a generates annotation data and delivers it to the management module 22a. The processes executed by the CPU (not shown) according to the editing module program 31a will be described below with reference to FIG. 3(a) through FIG. 3(c).

The display module program 31b is used to acquire annotation data, which is linked to the web page displayed by the web client 31, from the sending module (function based on a program) 22c and to display an annotation over a web page.

The communication interface program 32 is a TCP/IP stack as in the case of the web server machine 10.

Next, the process for registering, correcting, and deleting an annotation will be described.

First, when a predetermined operation is inputted to the web client machine 30 through the input device, the editing module program 31a starts.

FIG. 3(a) through FIG. 3(c) are flowcharts showing processes by the editing module program 31a.

The editing module (the CPU (not shown) that executes a program) 31a receives user information (user ID) from a user through an input screen or the like in a first step S101.

In the next step S102, the editing module 31a receives a network address (URL) of web page data 11 from an operator through the input screen etc.

In the next step S103, the editing module 31a acquires the web page data 11 that is specified by the network address received in step S102 from the web server (the CPU (not shown) that executes a program) 12.

In the next step S104, the editing module 31a acquires all pieces of the annotation data that include the network address received in step S102 from the annotation server (the CPU (not shown) that executes a program) 22.

In the next step S105, the editing module 31a displays an edit screen on the display. The web page based on the web page data 11 acquired in step S103 and the annotation based on the annotation data acquired in step S104 are displayed in the edit screen. The annotation is displayed with relating to the position that is specified by the internal address included within the annotation data.

In the next step S106, the editing module 31a receives an operational instruction from the operator through an input device. The operational instruction may be a registration of an annotation, a correction of an annotation, a deletion of an annotation, a finish of operation, or another operation. The operational instruction for the registration of an annotation is a selection of the object displayed on the edit screen by a click or the like. The operational direction for the correction or the deletion of an annotation is a selection of the annotation displayed on the edit screen by a click or the like. The operational direction for the finish of operation is a click of a close button of the window, or a selection of an application finish menu. Another operational direction is, for example, a menu selection.

In the next step S107, the editing module 31a determines whether the operational instruction received in step S106 is the finish of operation. When the operational direction is the finish of operation, the editing module 31a finishes the process concerning FIG. 3(a) through FIG. 3(c). On the other hand, when the operational instruction is not the finish of operation, the editing module 31a branches the process from step S107 to step S108.

In step S108, the editing module 31a determines whether the operational direction received in step S105 is a selection of the object on the edit screen. When the operational direction is a selection of the object on the edit screen, the editing module 31a advances the process to step S109.

In the next step S109, the editing module 31a specifies a logical position of the object, which is selected by the operational instruction received in step S106, on the web page. Specifically, the editing module 31a first specifies the respective blocks (the part sandwiched between a start tag and an end tag of the same element like <body> and </body> is one block) that are related in a tree structure in a source text of the web page data. Then, the module 31a generates information that specifies each block (information to specify routes and nodes, or a block ID (Identification) that is unique for each block) to analyze the configuration of the web page data. Next, the editing module 31a specifies the block that is specified by the specification received in step S108. Then, the module 31a defines the information that specifies the logical position of the block as the target internal address. For example, the internal address may be expressed by XPath and an offset, like “/HTML/BODY/TABLE/TR/TD 0”.

In the next step S110, the editing module 31a receives the description of the annotation through the input device from the operator.

In the next step S112, the editing module 31a generates annotation data including the user information (user ID) received in step S101, the internal address of the logical position specified in step S109, and the contents information that specifies the contents received in step S110. Then, the editing module 31a sends the annotation data and a registration request to the management module (function based on a program) 22a of the annotation server (function based on a program) 22. After sending the registration request, the editing module 31a returns the process to step S106.

In step S108, when the operational direction is not a selection of the object on the edit screen, the editing module 31a branches the process from step S108 to step S113.

In step S113, the editing module 31a determines whether the operational direction received in step S105 is a selection of the annotation on the edit screen. When the operational instruction is a selection of the annotation on the edit screen, the editing module 31a advances the process to step S114.

In the next step S114, the editing module 31a receives an operational direction from the operator through a menu screen, etc. The operational direction is one of a deletion of an annotation, a correction of an annotation position, or a correction of annotation contents.

In the next step S115, the editing module 31a determines whether the operational instruction received in step S114 is a deletion of the annotation. When the operational instruction is a deletion of the annotation, the editing module 31a advances the process to step S116.

In step S116, the editing module 31a sends the user information (user ID) received in step S101, the annotation ID of the annotation that is selected when the deletion direction was received, and a deletion-request for the annotation to the management module 22a. Then, the editing module 31a returns the process to step S106.

In step S114, when the operational direction received in step S114 is a correction of the annotation position or the annotation contents and is not a deletion of the annotation, the editing module 31a branches the process from step S115 to step S117.

In step S117, the editing module 31a determines whether the operational direction received in step S114 is a correction of the annotation position. When the operational direction is a correction of the annotation position, the editing module 31a advances the process to step S118.

In step S118, the editing module 31a receives a selection of an object on the edit screen through the input device from the operator.

In the next step S119, the editing module 31a specifies a logical position of the object, which is selected by the selection received in step S118, in the web page data. Then, the editing module 31a advances the process to step S122.

On the other hand, when the operational direction received in step S114 is a correction of annotation contents and is not a correction of the annotation position, the editing module 31a branches the process from step S117 to step S120.

In step S120, the editing module 31a receives the contents of the annotation through the input device from the operator. Then, the editing module 31a advances the process to step S122.

In step S122, the editing module 31a generates annotation data including the user information (user ID) received in step S101, the annotation ID of the annotation selected when the operation direction was received in step S106, and the internal address specified in step S119 or the contents information specifying the contents received in step S120. Then, the editing module 31a sends the correction request and the annotation data to the management module 22a. After sending the correction request, the editing module 31a returns the process to step S106.

On the other hand, when the operational direction received is not a selection of the annotation in step S113, the editing module 31a branches the process from step S113 to step S123.

In step S123, the editing module 31a executes a process according to the operational instruction received in step S106, and then, returns the process to step S106.

According to the process of the editing module 31a, the operator of the web client machine 30 can direct a registration, a correction, and a deletion of an annotation to the annotation server 22.

FIG. 4(a) and FIG. 4(b) are flowcharts showing a process by the management module program 22a within the annotation server program 22.

The management module program 22a is executed by the CPU (not shown) after starting the annotation server machine 20. In a first step S201, the management module (the CPU (not shown) that executes a program) 22a waits until receiving an operation request from the editing module 31a of any of web client machines 30. When receiving an operation request from any of web client machines 30, the management module 22a advances the process to step S202. The CPU (not shown) that executes the process in step S201 corresponds to the receiving function mentioned above.

In step S202, the management module 22a searches the authorization management table 22b using the user information (user ID) included in the operation request received in step S201 as a key.

In the next step S203, the management module 22a determines whether a record has been detected from the authorization management table 22b. And when no record has been detected from the authorization management table 22b, the management module 22a branches the process from step S203 to step S204. The CPU (not shown) that executes the process in steps S202 and S203 corresponds to the determination function mentioned above.

In step S204, the management module 22a sends information for displaying a lack of authorization to annotate to the web client 31 that sent the operation request. Then, the management module 22a finishes the process concerning FIG. 4(a) and FIG. 4(b).

On the other hand, in step S203, when a record could be detected from the authorization management table 22b, the management module 22a advances the process to step S205.

In step S205, the management module 22a determines whether the operation request received in step S201 is a deletion request. When the operation request received in step S201 is a deletion request, the management module 22a advances the process to step S206.

In step S206, the management module 22a deletes the annotation data, which corresponds to the annotation ID that is received with the deletion request in step S201, from the annotation database 21. A deletion of an annotation may be a change of status of the annotation data within the annotation database 21 to deletion status. Here, the deletion status means the condition to prohibit from sending the annotation data when the display module (function based on a program) 31 requests it, and does not mean the condition to delete the annotation data from the annotation database 21. The condition can be managed by a flag, for example. Then, the management module 22a finishes the process concerning FIG. 4(a) and FIG. 4(b).

On the other hand, in step S205, when it is determined that the operation request received in step S201 is not a deletion request, the management module 22a branches the process from step S205 to step S207.

In step S207, the management module 22a determines whether the operation request received in step S201 is a registration request. When the operation request received in step S201 is a registration request, the management module 22a advances the process to step S208.

In step S208, the management module 22a issues a new annotation ID to the annotation data that is received in step S201 with the registration request.

In the next step S209, the management module 22a registers the annotation data received in step S201 together with the annotation ID that is issued in step S208 to the annotation database 21. Then, the management module 22a finishes the process concerning FIG. 4(a) and FIG. 4(b).

On the other hand, in step S207, when it is determined that the operation request received in step S201 is not a registration request, the management module 22a branches the process from step S207 to step S210.

In step S210, the management module 22a writes the annotation data that is received with the correction request in step S201 over the record having the same annotation ID in the annotation database 21. Then, the management module 22a finishes the process concerning FIG. 4(a) and FIG. 4(b). The CPU (not shown) that executes the process in steps S207 through S209 corresponds to the registration function mentioned above.

Next, an operation and an effect of the computer network system of the first embodiment will be described.

When the operator of the web client machine 30 launches the editing module program 31a by operating the input device (not shown) and inputs his or her user information (user ID) and a network address of a web page data, an edit screen is displayed on the display (not shown) (S101 through S105). In the edit screen, the web page specified by the operator and the annotation linked to the web page are displayed.

Then, when the operator selects an object on the edit screen and inputs contents of an annotation, a registration request is sent to the annotation server 22 (S112). When the operator selects an annotation on the edit screen and inputs the operational direction of correction, a correction request is sent to the annotation server 22 (S122). When the operator inputs an operational direction of deletion, a deletion request is sent to the annotation server 22 (S116) without requiring any operation.

After receiving the operational direction, the management module 22a checks whether the user who inputs the operational direction has authorization to annotate (S201 through S203). When the user has the authorization to annotate, the management module 22a continues the process corresponding to the operational direction (S205). On the other hand, when the user does not have the authorization to annotate, the management module 22a informs a lack of authorization to the user (S204).

The authorization of a user is checked using the authorization management table 22b, as mentioned above. The information in the authorization management table 22b is created by copying the information in the user management table 12a of the web server (function based on a program) 12. Therefore, an annotation can be operated by only a user who has access permission to the web page to which the annotation is linked. That is, according to the first embodiment, a person who can operate an annotation can be restricted only to a person who can access to the web page.

### Second Embodiment

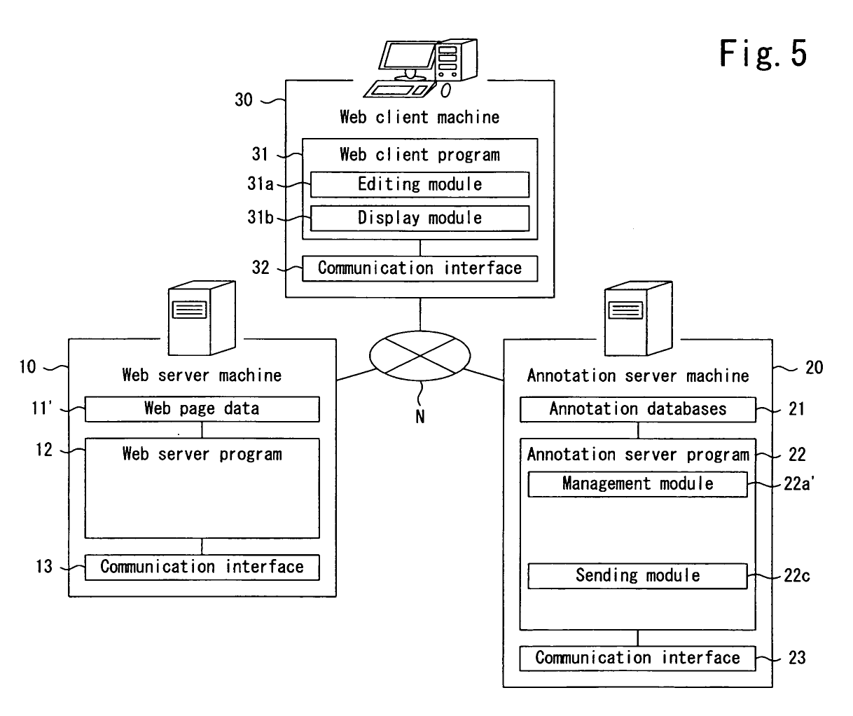

FIG. 5 shows a system configuration of a computer network system of the second embodiment.

In the second embodiment, the authorization for operating an annotation is not determined by the authorization to the operation (the process in steps S202 and S203, the authorization management table 22b), but is determined based on annotation control information described below that is embedded into web page data by a creator of the web page data. This is a difference from the first embodiment. However, the other configurations in hardware and software are basically identical to those of the first embodiment. As is evident from a comparison between FIG. 5 and FIG. 1, a reference letter of the management module program of the annotation server machine 20 in the second embodiment is different from that in the first embodiment. That's because the contents of the process of the management module program 22a′ in the second embodiment are slightly different from those in the first embodiment. Further, a reference letter of the web page data of the web server machine 10 in the second embodiment is different from that in the first embodiment. That's because the annotation control information described below is embedded into the web page data 11′ of the second embodiment. The web server program 12 of the second embodiment does not include the user management table 12a and the access management module 12b of the first embodiment. That's because the annotation server program 22 of the second embodiment does not include the authorization management table 22b of the first embodiment. That is, the web server machine 10 of the second embodiment may control an access to the web page data or may not control it.

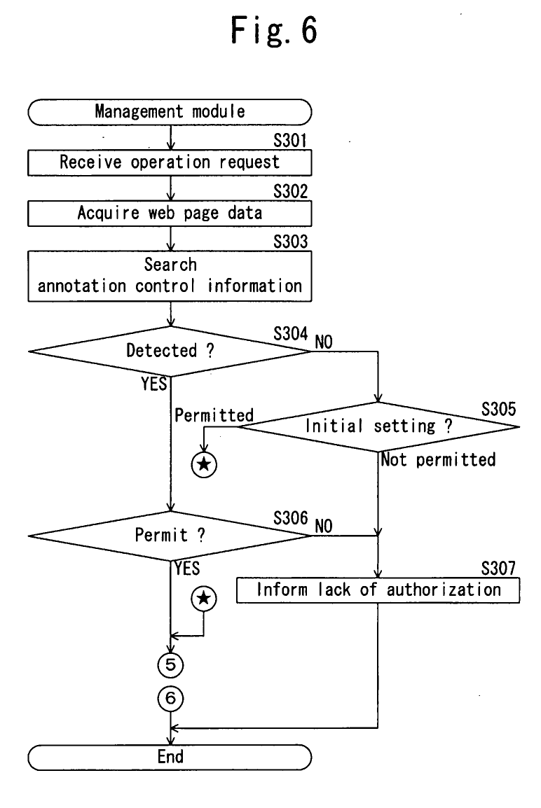

FIG. 6 is a flowchart showing a part of the process by the management module program 22a′ of the second embodiment. The process other than the part shown in FIG. 6 is in common with the part shown in FIG. 4(b). That is, the process by the management module program 22a′ of the second embodiment is a combination of the process in FIG. 6 and the process in FIG. 4(b).

In a first step S301, the management module (the CPU (not shown) that executes a program) 22a, which is started after launching the annotation server machine 20, waits until receiving an operation request from the editing module 31a of any of web client machines 30. When receiving an operation request from any of web client machines 30, the management module 22a′ advances the process to step S302. The CPU (not shown) that executes the process in step S301 corresponds to the receiving function mentioned above.

When receiving the registration request in step S301, the management module 22a′ acquires the network address from the annotation data that was received together with the registration request (S302). When receiving the correction request or the deletion request in step S301, the management module 22a′ reads the record having the annotation ID in the annotation data that was received together with the correction request or the deletion request from the annotation database 21. And then, the management module 22a′ acquires the network address from the read record. The management module 22a′ acquires the web page data 11′ that is specified by the acquired network address from the web server (the CPU (not shown) that executes a program) 12. The CPU (not shown) that executes the process in step S302 corresponds to the acquisition function mentioned above.

In the next step S303, the management module 22a′ searches the web page data 11′ acquired in step S302 for annotation control information. Here, the annotation control information is used for specifying a user who can annotate for the web page data 11′. For example, the annotation control information may include flag information that shows whether every user can annotate, user information (user ID) of a user who is permitted to operate an annotation, an IP address of a web client machine 30 of a user who is permitted to annotate, or information for specifying a type of a permitted operation (registration, correction, deletion).

In the next step S304, the management module 22a′ determines whether the annotation control information has been detected from the web page data 11′. When the annotation control information cannot be detected from the web page data 11′, the management module 22a′ branches the process from step S304 to step S305.

In step S305, the management module 22a′ reads the flag information and determines whether the flag information permits an operation of an annotation. The flag information shows initial settings that are used to determine whether an operation of an annotation is permitted when there is no annotation control information. If the flag information permits an operation of an annotation, the management module 22a′ branches the process from step S305 to step S205 in FIG. 4(b). If the flag information does not permit, the management module 22a′ advances the process to step S307.

On the other hand, in step S304, when the annotation control information can be detected from the web page data 11′, the management module 22a′ advances the process to step S306.

In step S306, the management module 22a′ determines whether the operation (registration, correction, or deletion) that was requested from the web client 31 is permissible based on the annotation control information detected from the web page data 11′ in step S304. When the operation that was requested from the web client 31 is permissible, the management module 22a′ advances the process to step S205 in FIG. 4(b). When it cannot be permitted, the management module 22a′ branches the process from step S306 to step S307. The CPU (not shown) that executes the process in steps S303 through S306 corresponds to the determination function mentioned above.

In step S307, the management module 22a′ sends the information for displaying that the user does not have authorization to perform the operation requested by the web client 31 to the web client 31 that sent the operation request. Then, the management module 22a′ finishes the process concerning FIG. 6 and FIG. 4(b).

On the other hand, when the operation that was requested from the web client 31 is permitted (S305; permitted, S306; YES), the management module 22a′ executes a process according to the type of the operation request that was received in step S301 (S205 through S210). That is, if the operation request that was received in step S301 is a deletion request, the management module 22a′ deletes the annotation data having the annotation ID that was received together with the deletion request from the annotation database (S206). If the operation request that was received in step S301 is a registration request, the management module 22a′ issues a new annotation ID to the annotation data that was received together with the registration request, and the module registers it to the annotation database 21 (S208, S209). If the operation request that was received at step S301 is a correction request, the management module 22a′ detects the annotation data having the annotation ID that was received together with the correction request from the annotation database 21, and the module updates the annotation data by overwriting (S210). The CPU (not shown) that executes the process in steps S207 through S209 corresponds to the registration function mentioned above.

Next, an operation and an effect of the computer network system of the second embodiment will be described.

Receiving an operation request from the web client machine 30, the management module 22a′ of the annotation server 22 checks whether the operation request is permissible based on the annotation control information of the web page data concerning the operation request (S304, S306). If the operation request is permissible, the process corresponding to the operation request is continued (S205 through S210). However, when the operation request is not permissible or when the initial settings for the case when the annotation control information is not included do not permit an operation of an annotation, a user is informed as such (S305; not permitted, S306; N0, S307).

Here, the annotation control information is embedded into the web page data 11′ by a creator of the web page data 11′. Therefore, the creator can restrict users who can annotate to the web page corresponding to the web page data 11 using the annotation control information embedded into the web page data 11′. That is, according to the second embodiment, the creator of the web page data 11′ can control the annotation to the web page data.

### Third Embodiment

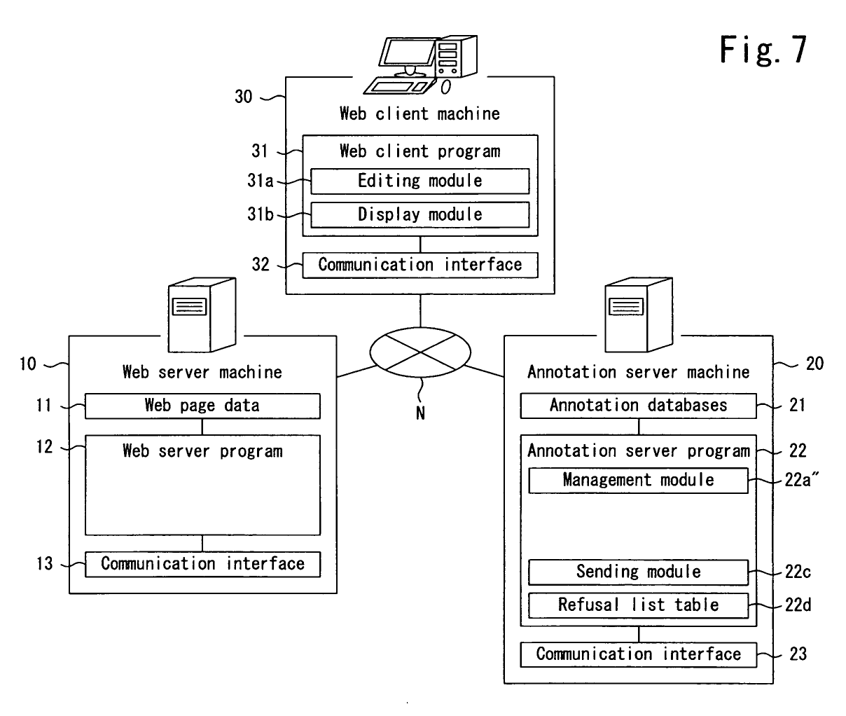

FIG. 7 shows a system configuration of a computer network system of the third embodiment.

The third embodiment determines whether contents of an annotation are permissible when the annotation is registered or when its contents are corrected. That is a difference from the first and second embodiments that determine whether an operation of an annotation is permissible (S202, S203 in FIG. 4(a), and S302 through S307 in FIG. 6). The other configurations in hardware and software are basically identical to those of the first and second embodiments. As is evident from a comparison of FIG. 7 with FIG. 1 and FIG. 5, a reference letter of the management module program of the annotation server machine 20 in the third embodiment is different from that in the first and second embodiments. That's because the contents of the process of the management module program 22a″ in the third embodiment are slightly different from those in the first and second embodiments. Further, a reference letter of the web page data of the web server machine 10 in the third embodiment is identical to that in the first embodiment. That's because the annotation control information of the second embodiment is not embedded into the web page data. The web server program 12 of the third embodiment does not include the user management table 12a and the access management module 12b of the first embodiment. That's because the annotation server program 22 of the third embodiment does not include the authorization management table 22b of the first embodiment. That is, the web server machine 10 of the third embodiment may control an access to the web page data or may not control it.

The annotation server program 22 of the third embodiment does not contain the authorization management table 22b of the first embodiment, but it contains a refusal list table 22d.

The refusal list table 22d stores a list of conditions of annotations that should not be registered into the annotation database 21. For example, the refusal list table 22d stores a user ID of a user who is not temporarily permitted to use the system, and a prohibition phrase that should not be contained in an annotation.

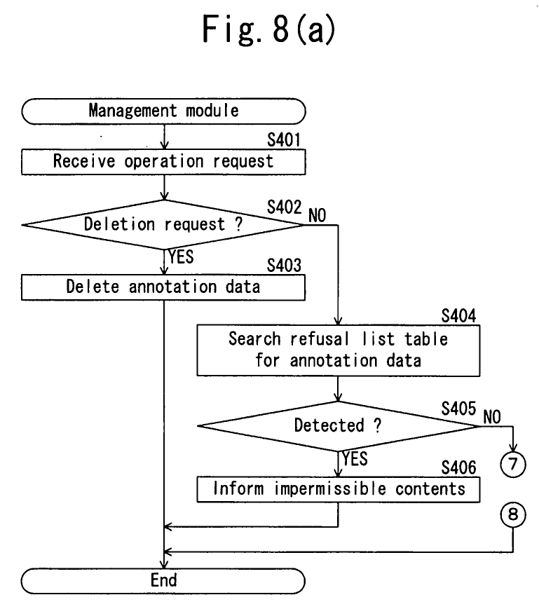

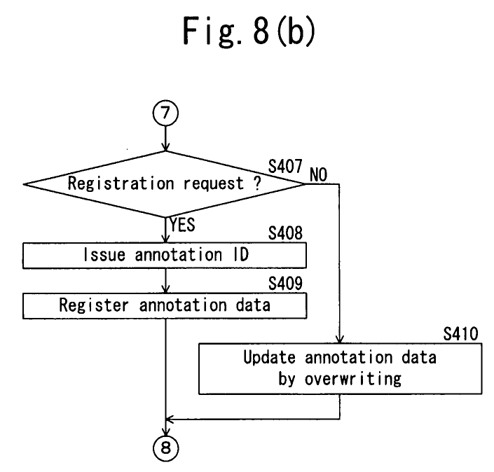

FIG. 8(a) and FIG. 8(b) are flowcharts showing a process by the management module program 22a″ according to the third embodiment.

In a first step S401, the management module (the CPU (not shown) that executes a program) 22a″, which is started after launching the annotation server machine 20, waits until receiving an operation request from the editing module 31a of any of web client machines 30. When receiving an operation request from any of web client machines 30, the management module 22a advances the process to step S402. The CPU (not shown) that executes the process in step S401 corresponds to the receiving function mentioned above.

In step S402, the management module 22a″ determines whether the operation request received in step S401 is a deletion request. When the operation request received in step S401 is a deletion request, the management module 22a″ advances the process to step S403.

In step S403, the management module 22a″ deletes the annotation data, which corresponds to the annotation ID that is received with the deletion request in step S401, from the annotation database 21. Alternatively, the management module 22a″ may change status of the annotation data within the annotation database 21 to deletion status. Then, the management module 22a″ finishes the process concerning FIG. 8(a) and FIG. 8(b).

On the other hand, in step S402, when it is determined that the operation request received in step S401 is not a deletion request, the management module 22a″ branches the process from step S402 to step S404.

In step S404, the management module 22a″ searches the refusal list table 22d for the annotation data that was received in step S401 together with a registration request or a correction request. Since the refusal list table 22d lists items such as a user ID and a prohibition phrase as mentioned above, the management module 22a″ searches the contents specified by the user information and the contents information of the annotation data using the individual items listed in the refusal list table 22d as keys.

In the next step S405, the management module 22a″ determines whether any item listed in the refusal list table 22d is detected in the annotation data that is received in step S401. If any item listed in the refusal list table 22d is detected in the annotation data concerned, the management module 22a″ advances the process to step S406. The CPU (not shown) that executes the process in steps S404 and S405 corresponds to the determination function mentioned above.

In step S406, the management module sends the information for displaying that the registration of the annotation or the correction of the contents of annotation is not permitted due to various conditions to the web client 31 that sent the operation request. Then, the management module 22a″ finishes the process concerning FIG. 8(a) and FIG. 8(b).

On the other hand, in step S405, when no item in the refusal list table 22d was detected in the annotation data concerned the management module 22a″ branches the process from step S405 to step S407.

In step S407, the management module 22a″ determines whether the operation request received in step S401 is a registration request. When the operation request received in step S401 is a registration request, the management module 22a″ advances the process to step S408.

In step S408, the management module 22a″ issues a new annotation ID to the annotation data that is received in step S401 together with the registration request.

In the next step S409, the management module 22a″ registers the annotation data that is received in step S401 together with the annotation ID that is issued in step S408 into the annotation database 21. Then, the management module 22a″ finishes the process concerning FIG. 8(a) and FIG. 8(b).

On the other hand, in step S407, when it is determined that the operation request received in step S401 is not a registration request, the management module 22a″ branches the process from step S407 to step S410.

In step S410, the management module 22a″ overwrites the record having the same annotation ID in the annotation database 21 with the annotation data that was received in step S401 together with the correction request. Then, the management module 22a″ finishes the process concerning FIG. 8(a) and FIG. 8(b). The CPU (not shown) that executes the process in steps S407 through S410 corresponds to the registration function mentioned above.

Next, an operation and an effect of the computer network system of the third embodiment will be described.

Receiving a registration request or a correction request from the web client machine 30, the management module 22a″ of the annotation server 22 checks whether the operation request is permissible (S401, S402; N0, S404, S405). When the operation request is not permissible because of satisfying the various conditions, a process concerning the operation (registration or correction) that is requested by the web client 31 is not executed and a user is informed as such (S406).

The management module 22a″ determines whether the operation request is permissible using the refusal list table as mentioned above. Therefore, according to the third embodiment, the administrator of the annotation server machine 20 can prevent operations that match items in the refusal list table 22d when the administrator registers the items that should not be included in an annotation such as a discriminatory phrase into the refusal list table 22d.

### Fourth Embodiment

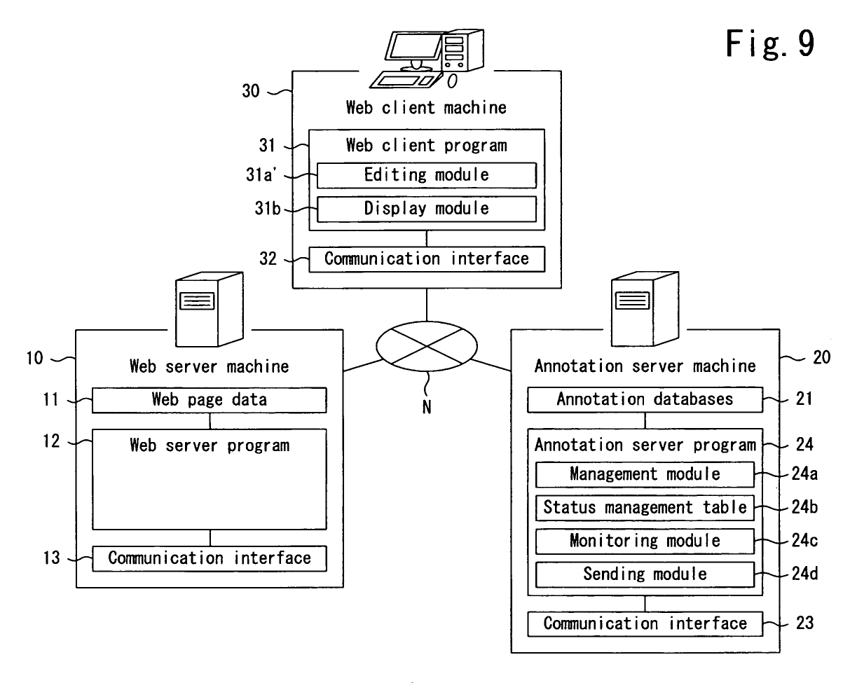

FIG. 9 shows a system configuration of a computer network system of the fourth embodiment.

In the fourth embodiment, when an operator of the web client machine 30 registers an annotation, the operator can set so that an action about the annotation occurs when a predetermined status has come. That is a difference from the first, second, and third embodiments that restrict an operation about an annotation based on the information (the authorization management table 22b in FIG. 1, the annotation control information in the web page data 11′ in FIG. 5, or the refusal list table 22d in FIG. 7). However, the other configurations in hardware and software are basically identical to those of the first, second, and third embodiments. As is evident from a comparison of FIG. 9 with FIG. 7, FIG. 5, and FIG. 1, a reference letter of the annotation server program of the annotation server machine 20 in the fourth embodiment is different from that in the first, second, and third embodiments. The web server program 12 of the fourth embodiment does not include the user management table 12a and the access management module 12b of the first embodiment. That's because the annotation server program 24 of the fourth embodiment does not include the authorization management table 22b of the first embodiment. That is, the web server machine 10 of the fourth embodiment may control an access to the web page data or may not control it.

As show in FIG. 9, the annotation server program 24 of the fourth embodiment contains a management module program 24a, a status management table 24b, a monitoring module program 24c, and a sending module program 24d.

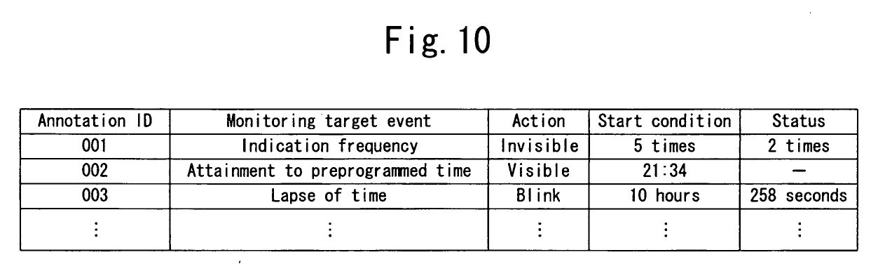

FIG. 10 shows an example of the data structure of the status management table 24b.

The status management table 24b stores information (action related information) about an action that an operator of the web client machine 30 selects for an annotation, etc. As shown in FIG. 10, specifically, each record of the status management table 24b has fields of an “annotation ID”, a “monitoring target event”, an “action”, a “start condition”, and a “status”. The “annotation ID” field stores an annotation ID. The “monitoring target event” field stores the type of event that is selected by a user as a monitoring target. The event includes a display of an annotation (a display event), a click (a click event), attainment to a preprogrammed time (a time-attainment event), and a lapse of time (a time-lapse event), for example. The “action” field stores action information for specifying an action (described below) that is performed when the monitoring target event becomes a predetermined status. The “start condition” field stores a condition of a monitoring target event for starting an action. The “status” field stores status of a monitoring target event.

When the monitoring target event registered in the status management table 24b occurs, the monitoring module program 24c shown in FIG. 9 checks whether the start condition is satisfied. If the start condition is satisfied, the monitoring module program 24c starts the action corresponding to the action related information that satisfies the start condition.

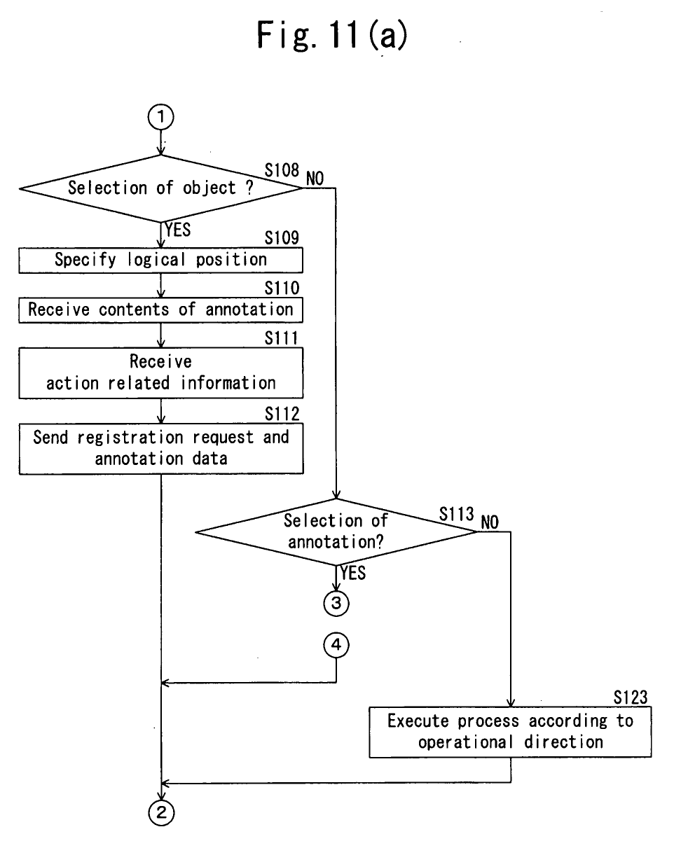

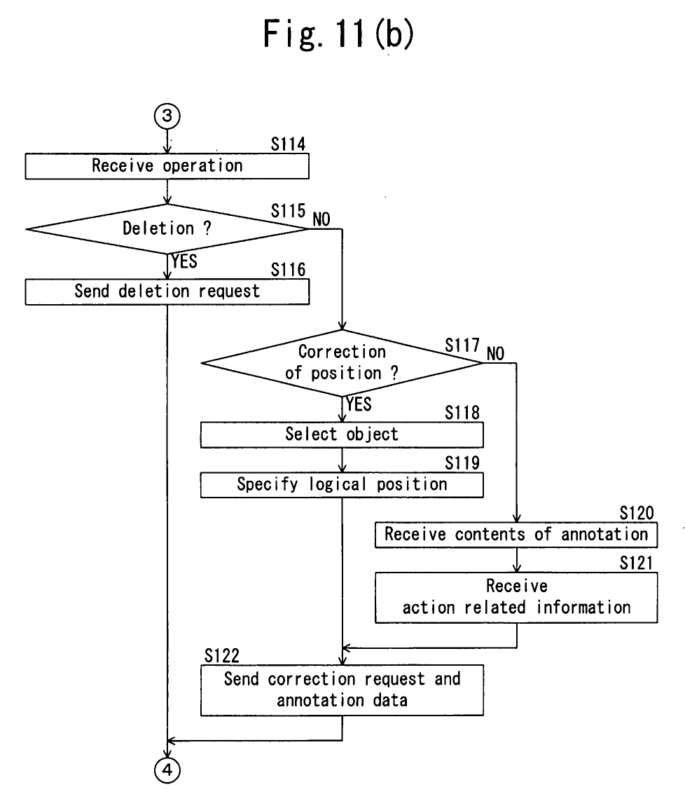

FIG. 11(a) and FIG. 11(b) are flowcharts showing the process by the editing module program 31a′. The process other than the part shown in FIG. 11(a) and FIG. 11(b) is in common with the part shown in FIG. 3(a). That is, the flow of process by the editing module program 31a′ in the fourth embodiment is a combination of the process in FIG. 3(a) and the process of FIG. 11(a) and FIG. 11(b).

As shown in FIG. 3(a), after starting, the editing module (the CPU (not shown) that executes a program) 31a′ receives user information (user ID) and a network address (URL) of a web page from an operator through an input screen etc. (S101, S102). Then, the module 31a′ acquires the web page data specified by the network address from the web server (the CPU (not shown) that executes a program) 12 (S103). The module 31a′ also acquires annotation data of all the annotations that contain the network address from the annotation server (the CPU (not shown) that executes a program) 22 (S104).

Then, the editing module 31a′ displays an edit screen on the display (S105). When receiving an operational direction from the operator through the input device (S106) the editing module 31a′ distinguishes the type of the received operational direction (S107, S108, S113). When the operational direction is a selection of the object on the edit screen (the case of the operational direction of registration of an annotation), the editing module 31a′ advances the process to step S109 in FIG. 11(a). When the operational direction is a selection of the annotation on the edit screen (the case of the operational direction of deletion of an annotation), the editing module 31a′ advances the process to step S114 in FIG. 11(b).

When the operational direction is a selection of an object on the edit screen, the editing module 31a′ specifies the logical position of the object that is specified by the operational direction in the webpage data (S109). Then, the editing module 31a′ receives contents of the annotation (S110).

After that, the process to send the annotation data and a registration request is executed in step S112 in the first embodiment. On the other hand, in the fourth embodiment, the process to receive the action related information is executed before that in step S111 as shown in FIG. 11(a).

In step S111, specifically, the editing module 31a′ receives a monitoring target event (a indication of an annotation, a click, attainment to a preprogrammed time, and a lapse of time), an action content (deletion of an annotation, visualization of an annotation, change of a display form of contents of an annotation), and a start condition (threshold of an indication frequency, threshold of a click frequency, a preprogrammed time, a time that should elapse) from the operator through the input screen, etc.

The editing module 31a′ acquires the action related information as mentioned above, and then, sends the annotation data and a registration request together with the action related information to the annotation server 22 (S112).

When the operational direction is a selection of an annotation on the edit screen, the editing module 31a′ receives an operational direction from the operator through a menu screen, etc. The operational direction is one of a deletion of an annotation, a correction of an annotation position, or a correction of annotation contents.

When the operational direction is a contents correction of an annotation, the editing module 31a′ receives contents of the annotation from the operator and receives the action related information (S120, S121). Then, the module 31a′ sends the action related information, the annotation data, and a correction request to the annotation server 22 (S122).

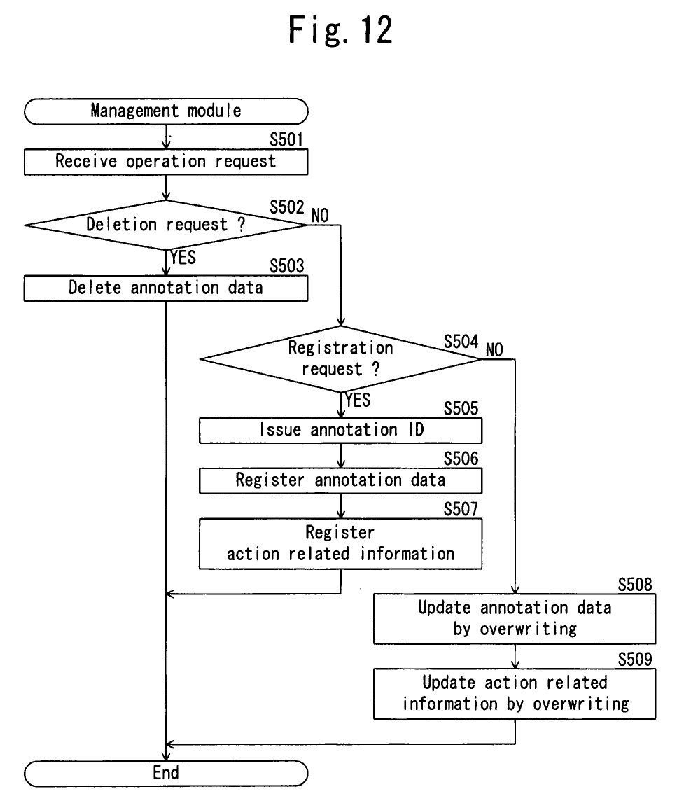

FIG. 12 is a flowchart showing a process by the management module program 24a according to the fourth embodiment.

In a first step S501, the management module (the CPU (not shown) that executes a program) 24a, which is started after launching the annotation server machine 20, waits until receiving an operation request from the editing module 31a′ of any of web client machines 30. When receiving an operation request from any of web client machines 30, the management module 24a advances the process to step S502. The CPU (not shown) that executes the process in step S501 corresponds to the receiving function mentioned above.

In step S502, the management module 24a determines whether the operation request received in step S501 is a deletion request. When the operation request received in step S501 is a deletion request, the management module 24a advances the process to step S503.

In step S503, the management module 24a deletes the annotation data, which corresponds to the annotation ID that is received with the deletion request in step S501, from the annotation database 21. Alternatively, the management module 24a may change status of the annotation data within the annotation database 21 to deletion status. Then, the management module 24a finishes the process shown in FIG. 12.

On the other hand, in step S502, when it is determined that the operation request received in step S401 is not a deletion request, the management module 24a branches the process from step S502 to step S504.

In step S504, the management module 24a determines whether the operation request received in step S501 is a registration request. When the operation request received in step S501 is a registration request, the management module 24a advances the process to step S505.

In step S505, the management module 24a issues a new annotation ID to the annotation data that is received in step S501 together with the registration request.

In the next step S506, the management module 24a registers the annotation data that is received in step S501 together with the annotation ID that is issued in step S508 into the annotation database 21.

In the next step S507, the management module 24a registers the action related information that is received in step S501 together with the registration request and the annotation ID that is issued in step S505 to the status management table 24b shown in FIG. 10. An initial value is recorded in the “status” field of the record registered at this time. When the monitoring target event is a display or a click, the initial value is zero times. When the monitoring target event is a lapse of time, the initial value is zero seconds. When the value of the “monitoring target event” field of the registered record is “attainment to a preprogrammed time” or “a lapse of time”, the management module 24a also generates a process that produces an interrupt when the preprogrammed time is attained or the predetermined time elapses. Then, the management module 24a finishes the process shown in FIG. 12.

On the other hand, in step S504, when it is determined that the operation request received in step S501 is not a registration request, the management module 24a branches the process from step S504 to step S508.

In step S508, the management module 24a overwrites the record having the same annotation ID in the annotation database 21 with the annotation data that was received in step S501 together with the correction request.

In the next step S509, the management module 24a updates the status management table 24b of FIG. 10. Specifically, the management module 24a writes a new record that consists of the action related information received in step S501 together with the correction request and the annotation ID in the annotation data received together with the correction request over the old record that has the same annotation ID. Then, the management module 24a finishes the process shown in FIG. 12. The CPU (not shown) that executes the process in steps S504 through S509 corresponds to the registration function mentioned above.

The management module 24a automatically registers the action related information, which is sent by the operator of the web client machine 30 to the annotation server 22 through the editing module 31a′, to the status management table 24b of FIG. 10.

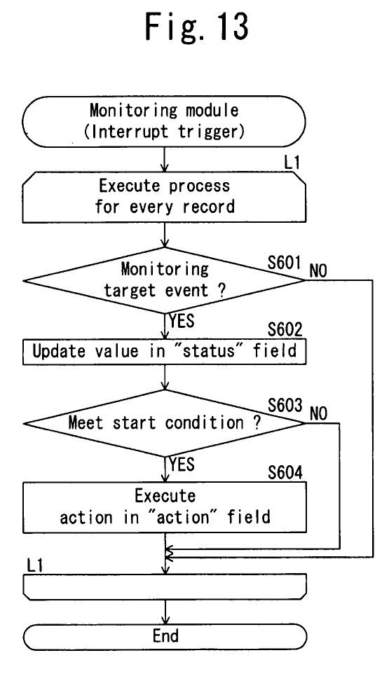

FIG. 13 is a flowchart showing a process by the monitoring module program 24c.

The process of the monitoring module program 24c is generated whenever a predetermined interrupt occurs. Here, the predetermined interrupt includes the display event, the click event, the time-attainment event, and the time-lapse event, for example. The display event is produced for the annotation ID of the annotation data by the sending module 24d when the display module 31b of the web clients 31 requires annotation data from the sending module 24d. The click event is produced for the web page by the web client 31 when a link button in the web page displayed with the annotation in the web client 31 is clicked. When the interrupt occurs, the monitoring module 24c executes a first process loop L1.

In the first process loop L1, the monitoring module 24c executes steps S601 through S604 for every record in the status management table 24b of FIG. 10.

In step S601, the monitoring module 24c determines whether the interrupt is produced by the event that is identical to the value in the “monitoring target event” field of the processing target record. When the interrupt is not produced by the event that is identical to the value in the “monitoring target event” field of the processing target record, the monitoring module 24c branches the process from step S601, and finishes the process with respect to the processing target record. On the other hand, when the interrupt is produced by the event that is identical to the value in the “monitoring target event” field of the processing target record, the monitoring module 24c advances the process to step S602.

In step S602, the monitoring module 24c updates the value of “status” field of the processing target record. If the monitoring target event is the display event or the click event, the monitoring module 24c increments the value of the “status” field by one. If the monitoring target event is the time-lapse event, the monitoring module 24c updates the value of the “status” field by overwriting it with the elapsed time (seconds).

In the next step S603, the monitoring module 24c determines whether the value of the “status” field of the processing target record is coincident with the value of the “start condition” field. When the value of the “status” field of the processing target record is not coincident with the value of the “start condition” field, the monitoring module 24c branches the process from step S603, and finishes the process with respect to the processing target record. On the other hand, when the value of the “status” field of the processing target record is coincident with the value of the “start condition” field, the monitoring module 24c advances the process to step S604.

In step S604, the monitoring module 24c executes an action (deletion of an annotation, visualization of an annotation, change of a display form of contents of an annotation, etc.) specified based on the value of the “action” field of the processing target record. These actions can be considered as the processes that change the flag contained in the annotation data in the annotation database 21. The flag/an annotation data/this flag may be a flag for changing a deletion condition (condition which is not distributed) and a register state, and], for example On the contrary, it may be a flag for changing the display forms (presence of a font and an underline, presence of the italic result, presence of blink, etc.) of an annotation. According to the condition of these flags, the web client 31 stops a display of an annotation, or starts a display of an annotation. The monitoring module 24c finishes the process with respect to the current processing target record, after executing the action.

When the monitoring module 24c has executed the process of steps S601 through S604 with respect to all the records in the status management table 24b of FIG. 10, it finishes the process concerning FIG. 13. The CPU (not shown) that executes the process concerning FIG. 13 corresponds to the switching function mentioned above.

Next, an operation and an effect of the computer network system of the fourth embodiment will be described.

When the operator of the web client machine 30 operates the input device (not shown) to launch the web client machine 30 and inputs his or her user information (user ID) and a network address of a web page data, the edit screen is displayed on the display device (not shown) (S101 through S105)). In the edit screen, the web page specified by the operator and the annotation linked to the web page are displayed.

Then, if the operator directs a registration request of an annotation or a correction request of contents of an annotation, the operation request and the action related information are sent to the annotation server 22 (S111, S112, S121, S122).

Receiving the operation request, the management module 24a of the annotation server program 24 executes the process according to the operation request. That is, when receiving the registration request or the correction request, the management module 24a registers or overwrites the annotation data received to the annotation database 21 and registers or overwrites the action related information to the status management table 24b.

In parallel to the process concerning the above operation requests, the process of the monitoring module 24c of the annotation server 24 is generated whenever the interrupt based on a predetermined event occurs. The monitoring module 24c updates the value of the “status” field of the record whose monitoring target matches the occurred events in the status management table 24b of FIG. 10 (S601; YES, S602). If the updated value is coincident with the start condition, the monitoring module 24c executes the action that is specified by the data in the “action” field of the record (S603; YES, S604).

Here, the monitoring target events, the actions, and the start conditions are set up by the user (annotator) who registers an annotation or corrects contents of an annotation. Therefore, a user not only registers an annotation as with the prior art, but also can set various patterns. For example, a user can set so that the annotation is displayed during a predetermined period. On the other hand, the user can set so that the annotation is not displayed during a predetermined period. Or a user can set so that a display form is changed after indications of a predetermined frequency. That is, according to the fourth embodiment, the annotator can control the display form of an annotation using events, such as a click and a time progress.

What is claimed is:

1. An annotation management program that controls a computer to execute functions comprising:
a storing function for storing annotation data, which includes a network address about web page data, contents information for specifying an annotation related with a web page corresponding to the web page data, and an internal address for specifying a position to which the annotation is linked on said web page, into an annotation database in a storage device;
a receiving function for receiving request information, which includes operation type information that specifies a type of an operation about an annotation and annotation information that specifies annotation data used for the operation, from a web client through a communication device;
a determination function for determining whether the request information satisfies a predetermined condition when said receiving function receives the request information; and
an execution function for executing the operation specified by the operation type information included in the request information to the annotation database when said determination function determines that said request information satisfies the predetermined condition.

2. The annotation management program according to claim 1 that controls a computer to execute functions further comprising:
an authorization storing function for storing user information for identifying a user in association with authorization specifying information for specifying a type of an operation that is permitted to the user into a table in said storage device,
wherein said receiving function receives said request information that contains said user information in addition to said operation type information and said annotation information from a web client through said communication device, and
wherein said determination function reads said authorization specifying information corresponding to said user information included in said request information that is received by said receiving function from said table, and determines whether the type of the operation specified by said authorization specifying information is coincident with the type of the operation specified by said operation type information in said request information that is received by said receiving function.

3. The annotation management program according to claim 1, wherein said determination function acquires, when said receiving function receives request information, web page data based on a network address in annotation data that is specified by the annotation information included in said request information, reads restriction information that specifies a condition to permit an operation of annotation in said web page based on the web page data acquired, and determines whether said request information received by said receiving function satisfies the condition based on said restriction information.

4. The annotation management program according to claim 3, wherein said determination function acquires, when said receiving function receives request information, web page data based on a network address in annotation data that is specified by the annotation information included in said request information, reads authorization specifying information that specifies a type of an operation of annotation permitted to the web page based on the web page data acquired, and determines whether the type of the operation specified by said authorization specifying information is coincident with the type of the operation specified by said operation type information in said request information that is received by said receiving function, and wherein said execution function executes the operation specified by the operation type information to the annotation database when said determination function determines that the type of the operation specified by said authorization specifying information is coincident with the type of the operation specified by said operation type information in said request information.

5. An annotation management method executed by a computer comprising:
a storing procedure for storing annotation data, which includes a network address about web page data, contents information for specifying an annotation related with a web page corresponding to the web page data, and an internal address for specifying a position to which the annotation is linked on said web page, into an annotation database in a storage device;
a receiving procedure for receiving request information, which includes operation type information that specifies a type of an operation about an annotation and annotation information that specifies annotation data used for the operation, from a web client through a communication device;
a determination procedure for determining whether the request information satisfies a predetermined condition when said receiving procedure receives the request information; and
an execution procedure for executing the operation specified by the operation type information included in the request information to the annotation database when said determination procedure determines that said request information satisfies the predetermined condition.

6. The annotation management method according to claim 5 further comprising: an authorization storing procedure for storing user information for identifying a user in association with authorization specifying information for specifying a type of an operation that is permitted to the user into a table in said storage device, wherein said receiving procedure receives said request information that contains said user information in addition to said operation type information and said annotation information from a web client through said communication device, and
wherein said determination procedure reads said authorization specifying information corresponding to said user information included in said request information that is received by said receiving procedure from said table, and determines whether the type of the operation specified by said authorization specifying information is coincident with the type of the operation specified by said operation type information in said request information that is received by said receiving procedure.

7. The annotation management method according to claim 5, wherein said determination procedure acquires, when said receiving procedure receives request information, web page data based on a network address in annotation data that is specified by the annotation information included in said request information, reads restriction information that specifies a condition to permit an operation of annotation in said web page based on the web page data acquired, and determines whether said request information received by said receiving procedure satisfies the condition based on said restriction information.

8. The annotation management method according to claim 7, wherein said determination procedure acquires, when said receiving procedure receives request information, web page data based on a network address in annotation data that is specified by the annotation information included in said request information, reads authorization specifying information that specifies a type of an operation of annotation permitted to the web page based on the web page data acquired, and determines whether the type of the operation specified by said authorization specifying information is coincident with the type of the operation specified by said operation type information in said request information that is received by said receiving procedure, and
wherein said execution procedure executes the operation specified by the operation type information to the annotation database when said determination procedure determines that the type of the operation specified by said authorization specifying information is coincident with the type of the operation specified by said operation type information in said request information.

9. An annotation management program that controls a computer to execute functions comprising:
a receiving function for receiving annotation data, which includes a network address about web page data, contents information for specifying an annotation related with a web page corresponding to the web page data, and an internal address for specifying a position to which the annotation is linked on the web page, from a web client through a communication device;
a determination function for determining whether the annotation data satisfies a predetermined condition when said receiving function receives the request information; and
a registration function for registering the annotation data into an annotation database when said determination function determines that the annotation data satisfies the predetermined condition.

10. The annotation management program according to claim 9, wherein said determination function determines whether the contents specified by the contents information in the annotation data that is received by said receiving function contain predetermined phrases.

11. An annotation management method executed by a computer comprising:
a receiving procedure for receiving annotation data, which includes a network address about web page data, contents information for specifying an annotation related with a web page corresponding to the web page data, and an internal address for specifying a position to which the annotation is linked on the web page, from a web client through a communication device;
a determination procedure for determining whether the annotation data satisfies a predetermined condition when said receiving procedure receives the request information; and
a registration procedure for registering the annotation data into an annotation database when said determination procedure determines that the annotation data satisfies the predetermined condition.

12. The annotation management method according to claim 11, wherein said determination procedure determines whether the contents specified by the contents information in the annotation data that is received by said receiving procedure contain predetermined phrases.

13. An annotation management program that controls a computer to execute functions comprising:
a receiving function for receiving annotation data, which includes a network address about web page data, contents information for specifying an annotation related with a web page corresponding to the web page data, and an internal address for specifying a position to which the annotation is linked on the web page, and action related information, which includes form specifying information for specifying a display form of the annotation after a change, and condition information for specifying a condition that causes the change, from a web client through a communication device;
a registration function for registering the annotation data into an annotation database and for registering the action related information into a management table when said receiving function receives the annotation data and the action related information;
a determination function for determining whether a condition specified by the condition information included in the action related information is satisfied for each of pieces of the action related information; and a switching function for switching the status of the corresponding annotation data in the annotation database so that the display form of the annotation matches the display form specified by the form specifying information when said determination function determines that the condition is satisfied.
